(19) United States
(12) Patent Application Publication
(10) Pub. No.: US 2025/0335260 A1
(43) Pub. Date: Oct. 30, 2025

(54) SCHEMA-BASED RESOURCE ALLOCATION FOR REQUEST PROCESSING

(71) Applicant: Shopify Inc., Ottawa (CA)

(72) Inventor: Jimmy BOURASSA, Montréal (CA)

(73) Assignee: Shopify Inc., Ottawa (CA)

(21) Appl. No.: 18/650,161

(22) Filed: Apr. 30, 2024

(51) Int. Cl. G06F 9/50

(52) U.S. Cl. CPC G06F 9/5044; G06F 9/5072

(57) ABSTRACT

Methods and systems for schema-based dynamic adjustment to per-job allocation limits, wherein the allocation limits are set as limits in computing resources allocated to processing a job request. A computing platform may determine a scaling factor for a default allocation limit based on fields selected by a query associated with a job request and the data shape of those fields in the data object referenced by the query. The schema to which the data object conforms may include one or more scale factors specified for its defined fields.

### TECHNICAL FIELD

The present disclosure relates to request handling in a computing environment and, in particular, to dynamic scaling of resource limits.

### BACKGROUND

The present disclosure relates to computing resource allocation and, in particular, to managing the allocation of computing resource for processing job requests. This can be a particular challenge in a multi-user computing platform involve third party developers where users may utilize third party applications to generate and send job requests to the computing platform or to trigger the generation of job requests upon the computing platform. To avoid malicious or accidental exhaustion of computing resources on the platform and consequential unexpected or unmanaged failures, resource allocation limits may be imposed on a per user, per application, or per job request basis in some systems.

Allocation limits may be imposed on one or more metrics. Example metrics may be related to, or proxies for, computational load. For example, allocation limits may be based on the size (in bytes) of the job request, the size (in bytes) of the data object(s) utilized or referenced by the job request, the number of instructions executed by the job request, or other such factors. Limits may be set per user, per application, or per job in some cases. Unfortunately, fixed limits may be too inflexible and may result in the failure of job requests that should be permitted.

### BRIEF DESCRIPTION OF THE DRAWINGS

Embodiments will be described, by way of example only, with reference to the accompanying figures wherein:

FIG. 1 shows an example computing system 200 implementing schema-based resource allocation;

FIG. 2 shows, in flowchart form, one example process for adjusting computing resource allocation limits;

FIG. 3A shows a high-level operation diagram of an example computing device;

FIG. 3B shows a simplified organization of software components for the example computing device;

FIG. 4 shows an example e-commerce platform; and

FIG. 5 illustrates an example home page of an administrator of the e-commerce platform.

Like reference numerals are used in the drawings to denote like elements and features.

### DETAILED DESCRIPTION OF EMBODIMENTS

In an aspect, the present application discloses a computer-implemented method that may include receiving, at a computing device, a job request having an associated query referencing one or more fields of a data object conforming to a schema; determining, by the computing device, a resultant scaling factor based on the one or more fields selected by the associated query and the data shape of those one or more fields in the data object, at least one of the one or more fields having an associated scale factor specified in the schema; adjusting an allocation limit based on the resultant scaling factor to produce an adjusted allocation limit, the allocation limit being a per-job allocation of a computing resource for execution of the job request; and executing, by the computing device, the job request subject to the adjusted allocation limit.

In some implementations, receiving includes receiving a compute job to execute. The query may be associated with the compute job, and executing may include executing the compute job subject to the adjusted allocation limit.

In some implementations, executing the job request subject to the adjusted allocation limited includes comparing a job execution parameter to the adjusted allocation limit; determining that the job execution parameter exceeds the adjusted allocation limit; and responsive to determining that the job execution parameter exceeds the adjusted allocation limit, terminating execution of the job request prior to its completion.

In some implementations, the job execution parameter corresponds to a least one of a CPU instruction count, a virtual machine instruction count, or processor time.

In some implementations, the data shape includes a count of the one or more fields in the data object.

In some implementations, the data shape includes a size of the one or more fields in the data object.

In some implementations, determining the resultant scaling factor includes multiplying the associated scale factor for one of said at least one of the one or more fields of the schema by a field size or row count for the one of said one or more fields in the data object.

In some implementations, the schema specifies a first scale factor associated with a first one of the one or more fields and a second scale factor associated with a second one of the one or more fields. Determining the resultant scaling factor may include determining a first resultant scaling factor based on the first scale factor and the data shape of the first one of the one or more fields in the data object; determining a second resultant scaling factor based on the second scale factor and the data shape of the second one of the one or more fields in the data object; and determining the resultant scaling factor using the first resultant scaling factor and the second resultant scaling factor. In some cases, determining the resultant scaling factor using the first resultant scaling factor and the second resultant scaling factor includes comparing and selecting the larger of the first resultant scaling factor and the second resultant scaling factor as the resultant scaling factor.

In some implementations, the associated query is a GraphQL query and the schema includes a directive specifying the associated scale factor associated with the at least one of the one or more fields.

In some implementations, the computing device comprises a multi-user computing platform and the job request includes an application program executing on the multi-user computing platform in response to a customer user input received at the multi-user computing platform, and the data object is a user-specific data object generated in response to customer user input activity on the multi-user computing platform.

In another aspect, the present application discloses a computing platform. The computing platform may include one or more processors and a memory coupled to the one or more processors. The memory stores computer-executable instructions that, when executed by the one or more processors, configure the one or more processors to carry out at least some of the operations of a method described herein.

In another aspect, the present application discloses a non-transitory, computer-readable medium storing processor-executable instructions that, when executed by a processor, are to cause the processor to carry out at least some of the operations of a method described herein.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

In large, multi-user platforms, care must be taken to allocate resources fairly and effectively to avoid or minimize program failures. The simplistic approach is to allocate a fixed set of resources (e.g. processor execution time, instruction count, input bytes, output bytes, or any other parameter) to each user. This is usually inefficient since not all users necessarily require the same allocation and it may result in wasted resources being allocated to some and others finding their programs fail to complete.

In the case of some multi-user platforms, there may be different types of users. For example, in an e-commerce platform, there may be merchant users that set up and configure and manage an online store. There may be customer users that browse items available in merchants' online stores and that may select and purchase one or more items through the platform. Third parties (developers, partners, shipping providers, payment processors, etc.) may also interface with the platform. Various applications and programs may be available on the platform, whether from the platform operator or deployed by one of the users, such as a developer, partner, shipping provider, payment processor, etc. The programs may act upon data present in the platform architecture. For example, a program may implement an aspect of check-out in relation to a shopping cart data structure, i.e. a data object.

The platform may implement resource constraints to protect the platform from large queries or high query rates. This also protects the platform from malicious agents. API request throttling may be implemented based on total number associated with a particular user over a window of time (e.g. rate limit), API input size, API response size, amount of computation required. In some cases, an API may be scored based on a number of factors aimed at estimating the processing load it represents. For example, write operations are more significant than read operations.

In some cases, an API request management facility may be configured to evaluate a variety of different API requests in order to score each API request in a manner that reflects the expected complexity of processing that request. The scoring is then used in conjunction with allocation limits to determine whether to process the API request. It will be appreciated that evaluating each API request for complexity in order to score it and compare it to an allocation limit is an expensive and time-consuming process for the platform in the effort to allocate resources fairly.

Another, simpler approach is to set a fixed allocation limit on a per-job basis. That is, each job request has a preset quantity of a metric. The metric may be a job execution parameter, such as central processing unit (CPU) or virtual machine (VM) instructions, processor time, “fuel”, or another metric. If the job request has not been completed by the time it consumes the allocated quantity of the job execution parameter, e.g. if the processor executes a count of instructions in processing the job request that meets the allocated limit, then the job request may be terminated.

This approach may result in the failure of job requests that should be permitted to run. For example, the queried data object may be unusually large and may require a larger than usual number of instructions to complete. In one simple solution, the system may adjust a per-job allocation limit dynamically based on actual processing needs of the job. That is, the system could base the adjustment on the query size, e.g. size of data object retrieved by query. In that case, a job request with an associated query that pulls a large data object will get extra allocation of resources. One downside to this approach is that it may motivate developers to structure job requests and associated queries to over-include data objects in order to gain extra resources for job processing; this might be referred to as “bit stuffing” to game the resource allocation.

Accordingly, in accordance with one aspect of the present application, allocation limits may be scaled based on the actual subset of data from a data object that is used in the job request, i.e. that is pulled by the parameters of the query associated with the job request. In this case, a data object may be quite large, but the associated query may only utilize one field or a short string, and the actual job request may have modest processing requirements.

To avoid some of the burden on the platform to monitor or have oversight over query processing and resource allocation, in accordance with another aspect of the present application, the scaling is built into the schema itself that governs the structure of data objects. A query referencing a data object structured according to a particular schema specifies a subset of the schema, e.g. one or more fields defined in the schema. The scaling may be specified within the schema for at least one of the fields or for each of those one or more fields. The scaling factor may be length-based for the field (e.g. field size) or length-based for an array (e.g. row count).

Advantageously, the above-described process sets the allocation limit scaling based on factors not necessarily under control of the developer, which prevents some potential gamesmanship with inputs in order to gain unwarranted allocation scaling. Instead, it presets the scaling based on factors generally under the influence of the online actions of a customer user, e.g. number of items in a shopping cart in the case of an e-commerce platform.

In GraphQL scaling can be implemented as a directive within the schema.

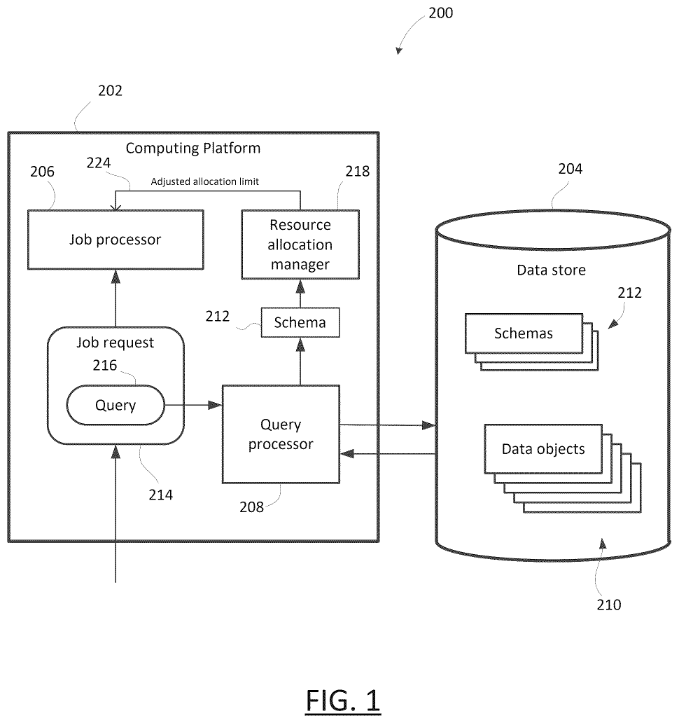

Reference will first be made to FIG. 1, which shows an example computing system 200 implementing schema-based resource allocation for job processing.

In this example, the computing system 200 include a computing platform 202 and a data store 204. The data store 204 may include multiple data storage units and types of memory and, although depicted separately from the computing platform 202, may include data storage within the computing platform 202 and/or may include data storage external to the computing platform 202 and connected to the computing platform 202 by one or more computer networks.

The data store 204 may contain data for operating the computing platform 202, such as data objects 210. The data objects 210 are, in some cases, particular instances of a data type or object or data structure. For example, a user interacting with the computing platform 202 may have an associated data object 210 recording data regarding that user's session with the computing platform 202.

At least some of the data objects 210 may be structured in accordance with one or more schemas 212. The schemas 212 may be code defining the data structure for particular types or classes of objects. For instance, a schema 212 may define one or more fields, their data types, their sizes, and/or other characteristics. A data object 210 may conform to its associated schema 212 in terms of its data structure and/or the types and arrangement of its fields. A specific instance of a data object 210 conforming to a schema 212 has a “data shape” depending on the actual data contained in the data object 210. For example, the schema 212 may define a field name “A” of a particular type, and the data object 210 may contain N rows of that field “A” each containing respective data of that particular type. As an illustrative example, the field “Selected Images” may be defined in the schema 212, and a particular user's instance of the data object 210 conforming to that schema may include an array of fields of “Selected Image”, with each row containing an image name: “apple.jpg”, “orange.jpg”, “lemon.jpg”, etc. Although the schemas 212 are shown within the data store 204 they may be stored elsewhere in memory within the computing platform 202.

The computing platform 202 may be a multi-tenant computing platform in some implementations. The computing platform 202 may be implemented by one or more computing devices, such as servers, and may be connected to one or more computer networks including the Internet for receiving and sending communications with remote devices. The computing platform 202 may offer a number of functions or operations to users of the computing platform 202. Application programming interfaces (APIs) may expose the functionality and data available within the computing platform 202. APIs may permit developer users to configure applications for execution on the computing platform 202 and/or on a user device in communication with the computing platform 202 that utilize functions, operations, and/or data made available by the computing platform 202. In some cases, the developer users may be permitted to develop APIs that are able to generate jobs for execution on the computing platform 202 using data available to the computing platform 202.

In some cases, users may interact with applications and/or APIs executing on the computing platform 202. Interactions with the applications and/or APIs may cause generation of a job request 214. The job request 214 may be generated at a user device and transmitted to the computing platform 202 in some cases. The job request 214 may be generated on the computer platform 202 as a result of user interaction with the computing platform 202 via a remote user device such as through a web interface or mobile application or an API. In either case, the job request 214 may be executed by a job processor 206 within the computing platform 202.

The job request 214 may have an associated query 216. The query 216 may reference one or more of the data objects 210. In particular, the query 216 may select one or more of the fields within the specified data object 210. The computer platform 202 may include a query processor 208 configured to carry out the query 216 and to return the requested data. Although shown as a separate element, the query processor 208 may be implemented within the job processor 206.

In order to protect the computing platform 202 from inadvertent or malicious requests, and to fairly allocate computing resources among users, the computing platform 202 may implement constraints on job request processing. The constraints may be implemented by having the job processor 206 process job requests subject to the prescribed constraint, in some cases. For example, the job processor 206 may impose a default allocation limit per job request. The default allocation limit may be a limit or constraint imposed on each job request. For example, the default allocation limit may be a maximum number of CPU instructions. In another example, the default allocation limit may be a maximum number of virtual machine (VM) instructions. In a further example, the default allocation limit may be a maximum processor time. In yet a further example, the default allocation limit may be a maximum “fuel” or “gas” usage, where fuel/gas usage is a form of estimating computational load within WebAssembly (WASM). Other mechanisms for measuring or metering computational burden of a job request may be used as the basis of the default allocation limit in other implementations.

In this example, the computing platform 202 and, in particular, the job processor 206, may use an adjusted allocation limit 224. The adjusted allocation limit 224 may be the default allocation limit scaled based on a scaling factor. The scaling factor may be determined based on the query 216 associated with job request 214 and the actual data shape of the data object 210 referenced by the query 216. That is, the default allocation limit may be adjusted based on specific fields or field types selected by the query 216 and, in particular, a scaling factor determined based on the size or count of fields within the data object 210 that are among the one or more fields referenced by the query 216.

FIG. 1 shows the computing platform 202 as including a resource allocation manager 218 that takes the data object 210, query 216, and schema 212 as inputs. In some cases, it may take the fields/content returned by the query 216 as input together with the schema 212. The resource allocation manager 218 may determine the scaling factor to be applied to the default allocation limit based on the selected one or more fields of the data object 210 and one or more scale factors specified within the schema 212 for those one or more fields. Although shown as separate element of the computing platform 202, the resource allocation manager 218 may not be a standalone component and may be implemented within the job processor 206 or other portions of the computing platform 202. The functions of the resource allocation manager 218 may be implemented in computer code governing the processing of job requests and the measuring of job request execution against allocation limits.

As noted, the resource allocation manager 218 adjusts the default allocation limit based on the data object 210 selected by the query 216 and, in particular, the field or fields from the data object 210 selected by the query 216. It references the schema 212 associated with the data object 210 to the extent that the schema 212 has the scale factors for specific fields or field types built into its definition. That is, the resource allocation manager 218 determines what scale factor to use for a particular field based on the schema 212. Using that scale factor for a particular field and a count of the number of that field in the data object 210, or a size of that field in the data object 210, the resource allocation manage 218 determines the scaling factor to be used in adjusting the default allocation limit to arrive at the adjusted allocation limit 224.

As an illustrative example, consider a schema that specifies one or more particular fields, which in this example are related fields named “Item” and “Location”. In this example, the schema is a GraphQL schema, although the present application is not limited to GraphQL. In this example, the schema defines a field type for location having a list of items associated with that location. The schema defining the fields may set a scale factor:

```
type Location {
  name: String
  # Scales at 1% per item
  items: [Item] @scaleLimits(rate: 0.01)
}
type Item {
  label: String
  location: Location
}
```

The above example schema specifies that the allocation limit scales at 0.01 (1%) per item included in the list of items at a particular location in a data instance that conforms to this schema. The scale factor in this example is 0.01. That is, if a query references a data object that returns a particular location (or all locations), and associated lists of items at that or those locations, then the scaling of the default allocation limit is based on the scale factor specified in the schema for the list or array “items” and on a count of items returned by the query, i.e. a count of rows in the array.

In this example, the scheme includes the directive @scaleLimits with the argument “rate: 0.01”. The schema includes a definition for the custom directive @scaleLimits that defines the schema's behaviour in connection with the directive. In some cases, the directive may indicate that the scale factor be applied based on a count of rows. In some cases, the directive may indicate that the scale factor be applied by as on a size of the field, e.g. a number of bytes.

Note that this is one simple example in which the scale factor starts impacting the allocation limit for every row (e.g. item) in the queried data object in the queried array/field. In another implementation, an “after” parameter may be set as part of the scale factor to indicate that the scale factor only starts to be applied after a specified size of field or specified count of rows. For instance, the scale factor may only start to be applied after the count of rows reaches or exceeds 100. In yet another implementation, an “upTo” parameter may be set as part of the scale factor to indicate a maximum. For instance, if the scale factor is 0.01 per row/entry, and an upTo parameter is set at 0.75 then the maximum cumulative scaling factor would be 75%. That is, once the count of rows reaches 75 no further scaling would be applied to the allocation limit to account for more than 75 rows. This may avoid scaling of allocation limits due to unexpectedly large or unwieldy data objects that would result in potential resource problems if a cap were not put on adjusted allocation limits.

In some examples, a query may reference more than one defined field or array in a data object. Some fields may be defined to scale based on field length. Some fields may be defined to scale based on item count (e.g. array length). In one implementation, the system may combine a first scaling factor determined based on one field and its associated first scale factor with a second scaling factor determined based on another field and its associated second scale factor in order to generate an overall or resultant scaling factor. In some cases, the two scaling factors may be added to each other. In some cases, the two scaling factors may be combined in some other way. In some cases, the larger of the two scaling factors may be selected as the resultant scaling factor. The resultant scaling factor is then used to adjust the default allocation limit to arrive at the adjusted allocation limit.

In the following illustrative example, a schema relates an order data object in the context of an e-commerce platform. The order data object may include a number of fields, such as the field orderItems that relates to the number of order items selected by a user for inclusion in the order data object, and the field itemAttributes, which lists one or more pieces of information about the items. Example attributes may include cost of items, location(s) at which the item is available, quantity of the item, etc.

An example schema may be partly defined as follows:

```
type Query {
  httpResponseBody: String @scaleLimits(rate: 1)
  orderItems: [OrderItem!]! @scalelimits(rate: 1)
}
Type OrderItem {
  itemAttributes: [String!]! @scaleLimits(rate: 1)
}
```

In this simplified example, the scale factor specified for each field is “1”. The field “httpResponseBody” applies the scale factor based on the length of the string field. The fields orderItems and itemAttributes both apply the scale factor based on the ‘length’ of the list (array) defined for those fields.

Assuming a data object structured in accordance with this example schema, a query may return a result such as the following:

```
{
  “httpResponseBody” : “abcf”,
  “orderItems”: [
    { “itemAttributes” : [“1”, “2”]},
    { “itemAttributes” : [“4”, “5”, “6”]}
  ]
}
```

Referencing the scale factors specified by the schema for these fields, the resultant scaling factors for each field based on the data shape are:

| | | |
|---|---|---|
| Query.httpResponseBody | length = 4 | factor = 4 |
| Query.orderItems | length = 2 | factor = 2 |
| OrderItem.itemAttributes | length = 2 | factor = 2 |
| OrderItem.itemAttributes | length = 3 | factor = 3 |

It will be noted that the above example results in a scaling factor of 4 based on the httpResponseBody string having a length of four characters. The orderItems array has two entries of itemAttributes, resulting in a scaling factor of 2 attributable to that field. Within the orderItems field, the two different itemAttributes fields have resultant scaling factors of 2 and 3 based on a count of number of items/rows in those respective arrays.

In one example, the scaling factors may be summed to generate an overall scaling factor of 4+2+2+3=11. In the present example, however, the highest factor is selected as the resultant scaling factor, where scaling factors for the same field type are summed. That is, the OrderItem.itemAttributes field ends up having a resultant scaling factor of 5 from a sum of the 2 and 3 factors attributable to the respective fields/arrays. The different scaling factors for different fields types are thus:

| Field | Factor |
|---|---|
| Query.httpResponseBody | 4 |
| Query.orderItems | 2 |
| OrderItem.itemAttributes | 5 |

Other mechanisms for combining and/or selecting scaling factors may be used in cases where there are multiple scaling factors due to multiple field types being selected by the query.

In some cases, the scale factors, such as 0.01 or 0.005, specify a percentage increase to the allocation limit. In some implementation, the system may start with a default scaling factor of 1. A resultant scaling factor of 0.85 may be determined based on a field having a scale factor specified in the schema of 0.005 for that field, and based on the query selecting that field in a data object in which the field has a length (whether in terms of string length or array rows) of 170. Therefore, the system adjusts the default scaling factor of 1 by adding 0.85 to obtain a resultant scaling factor of 1.85. This factor is then used to adjust the per-job resource allocation limit through multiplying the applicable limit by 1.85 to obtain the adjusted allocation limit. As noted above, the allocation limit may be expressed in terms of CPU instructions, VM instructions, processor time, “fuel”, or some other metric that is associated with computational load.

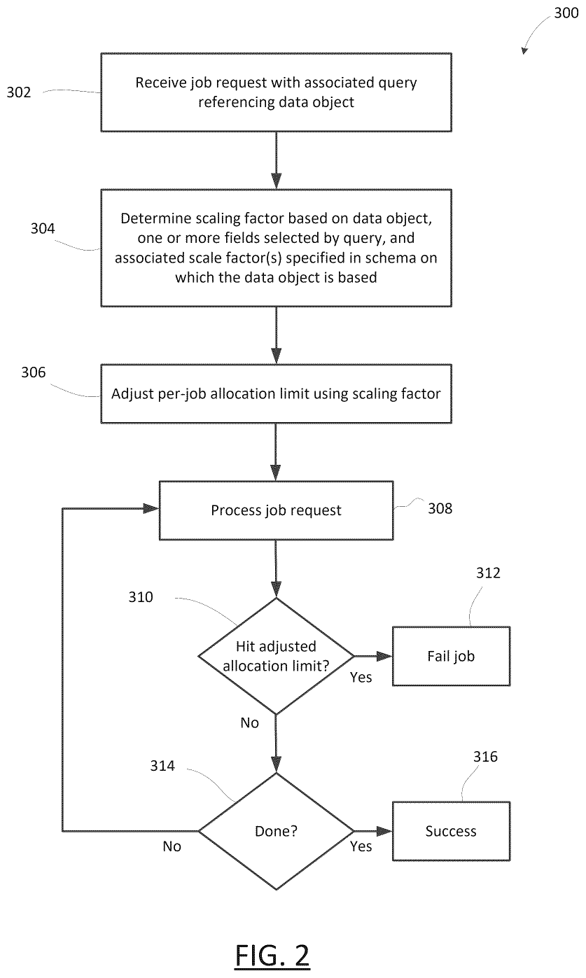

Reference is now made to FIG. 2, which shows, in flowchart form, one example process 300 for allocating computing resources. The process 300 may be implemented by one or more computing devices. For example, the process 300 may be implemented on a multi-tenant computing platform, that may be built using a plurality of servers and a data center. The process 300 may be implemented using any suitable computing language. In one example, the process 300 is at least partly implemented using GraphQL for defining schemas for data objects.

In operation 302, the computing device receives a job request. The job request may be received by virtue of an API call from a remote user device in communication with the computing device. The remote user device may have an established session with the computing device. The remote user device may be executing an application configured to connect with and exchange communications with the computing device. The job request may be generated at the computing device based upon one or more communications from the remote user device or in response to other operations on the computing device triggered by communications from the remote user device.

The job request includes an associated query referencing a data object. In particular, the query references one or more fields of the data object. The data object conforms to a schema. The schema may be defined and stored in memory on the computing device or in memory to which the computing device has access.

In this example, the computing device imposes a computing resource allocation limit on job requests. In particular, in this instance the allocation limit is a per-job allocation of a particular computing resource. The allocation limit may be implemented as a cap or maximum on a computational metric associated with the job request. The allocation limit may be expressed in terms of CPU instructions, VM instructions, processor time, “fuel”, or some other metric.

In operation 304, the computing device determines a scaling factor to be applied to the allocation limit. The determination of the scaling factor may be based on the one or more fields of the data object referenced in the query associated with the job request. The schema may specify, for at least one of the one or more fields, an associated scale factor. Based on the associated scale factor for the one of the one or fields and the contents of the data object associated with that one of the one or more field, the computing device determines the resultant scale factor. As described above, the scale factor may specify a scale adjustment based on the length of the field, whether length is expressed in terms of length of a string or in terms of count of row/fields in an array. The scale factor may be multiplied by the length in some cases. In some cases, the scale factor may be configured to only apply to length after a preset minimum length. In some cases, the scale factor may be subject to a maximum length after which it ceases to apply. In this manner, the resultant scaling factor is based on the data shape of the one or more fields of the data object selected by the query and on the scale factor(s) associated with those one or more fields.

In operation 306, the computing device uses the adjusted scaling factor to adjust the per-job allocation limit. In some implementations, where the adjusted scaling factor is expressed as a percentage increase to the allocation limit (e.g. 0.67), the adjustment may involve adding it to 1 and multiplying the allocation limit by the result (e.g. 1.67). In some cases, the adjusted scaling factor may be expressed as an absolute value (e.g. 100000 instructions), and a default allocation limited (e.g. 1,000,000 instructions) may be adjusted by the scaling factor to obtain an adjusted allocation limit of 1,100,000 instructions. It will be appreciated that such an implementation is not technically a ‘scaling factor’ in some sense, but is intended to fall within the scope of the term “scaling factor” as used in the present application.

In operation 308, the computing device processes the job request. This may include executing code or computing instructions associated with processing the job request. While processing the job request, the computing device may determine whether the processing of the job request results in meeting or exceeding the adjusted allocation limit in operation 310. This may include comparing a job execution parameter to the adjusted allocation limit. The job execution parameter may be the applicable metric used in specifying the limit, such as a count of CPU instructions, a count of VM instructions, elapsed processor time, used “fuel”, or some other metric. If the limit is reached or exceeded in operation 310, then the job may be halted and processing may not be completed as indicated by operation 312. The computing device may be configured to fail the job request gracefully in such circumstances and may provide a notification or other output or communication message signaling that the job request hit an adjusted allocation limit that caused the failure. If the limit is not reached, then the processing continues until the processing of the job request is successfully completed, as indicated by operations 314 and 316.

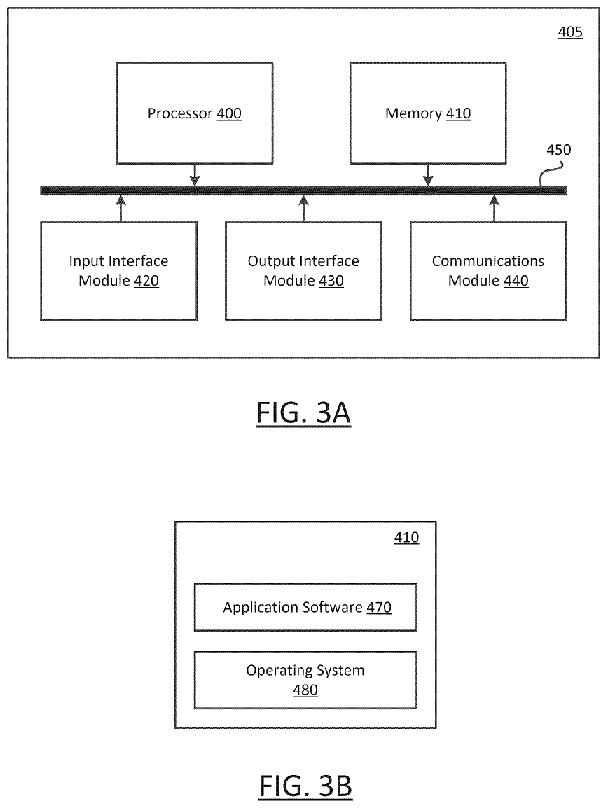

The above-described methods may be implemented by way of a suitably programmed computing device. FIG. 3A is a high-level operation diagram of an example computing device 405. The example computing device 405 may include a processor 400, a memory 410, an input interface 420, an output interface 430, and a communications subsystem 440. As illustrated, the foregoing example elements of the example computing device 405 are in communication over a bus 450.

The processor 400 is a hardware processor. The processor 400 may, for example, be one or more ARM, Intel x86, PowerPC processors or the like.

The memory 410 allows data to be stored and retrieved. The memory 410 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 405.

The input interface 420 allows the example computing device 405 to receive input signals. Input signals may, for example, correspond to input received from a user. The input interface 420 may serve to interconnect the example computing device 405 with one or more input devices. Input signals may be received from input devices by the input interface 420. Input devices may, for example, include one or more of a touchscreen input, keyboard, trackball or the like. In some embodiments, all or a portion of the input interface 420 may be integrated with an input device. For example, the input interface 420 may be integrated with one of the aforementioned examples of input devices.

The output interface 430 allows the example computing device 405 to provide output signals. Some output signals may, for example allow provision of output to a user. The output interface 430 may serve to interconnect the example computing device 405 with one or more output devices. Output signals may be sent to output devices by output interface 430. Output devices may include, for example, a display screen such as, for example, a liquid crystal display (LCD), a touchscreen display. Additionally, or alternatively, output devices may include devices other than screens such as, for example, a speaker, indicator lamps (such as, for example, light-emitting diodes (LEDs)), and printers. In some embodiments, all or a portion of the output interface 430 may be integrated with an output device. For example, the output interface 430 may be integrated with one of the aforementioned example output devices.

The communications subsystem 440 allows the example computing device 405 to communicate with other electronic devices and/or various communications networks. For example, the communications subsystem 440 may allow the example computing device 405 to send or receive communications signals. Communications signals may be sent or received according to one or more protocols or according to one or more standards. For example, the communications subsystem 440 may allow the example computing device 405 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications subsystem 640 may allow the example computing device 605 to communicate using near-field communication (NFC), via Wi-Fi™, using Bluetooth™ or via some combination of one or more networks or protocols. Contactless payments may be made using NFC. In some embodiments, all or a portion of the communications subsystem 440 may be integrated into a component of the example computing device 405. For example, the communications module may be integrated into a communications chipset.

Software comprising instructions is executed by the processor 400 from a computer-readable medium. For example, software may be loaded into random-access memory from persistent storage of memory 410. Additionally, or alternatively, instructions may be executed by the processor 400 directly from read-only memory of memory 410.

FIG. 3B depicts a simplified organization of software components stored in memory 410 of the example computing device 405. As illustrated these software components include an operating system 480 and application software 470.

The operating system 480 is software. The operating system 480 allows the application software 470 to access the processor 400, the memory 410, the input interface 420, the output interface 430, and the communications subsystem 440. The operating system 480 may be, for example, Apple™ OS X, Android™, Microsoft™ Windows™, a Linux distribution, or the like.

The application software 470 adapts the example computing device 405, in combination with the operating system 480, to operate as a device performing particular functions.

### Example E-Commerce Platform

In some examples, the multi-tenant computing platform may be an e-commerce platform. Although not required, in some embodiments, the methods disclosed herein may be performed on or in association with an e-commerce platform. An example of an e-commerce platform will now be described.

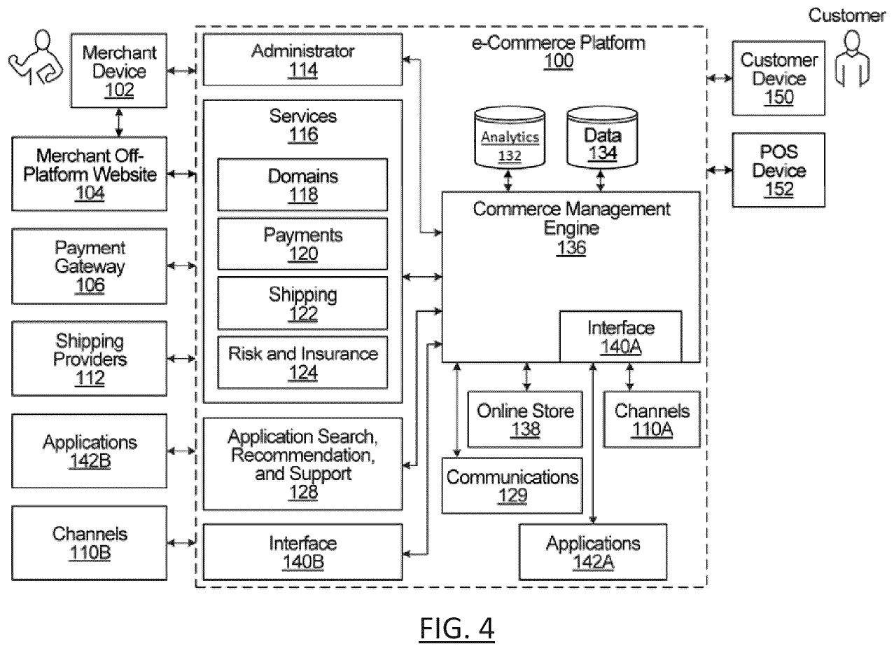

FIG. 4 illustrates an example e-commerce platform 100, according to one embodiment. The e-commerce platform 100 may be exemplary of the e-commerce platform 1002 described with reference to FIG. 1. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, additionally or alternatively, be provided by one or more providers/entities.

In the example of FIG. 4, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure, the terms online store and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a transitory memory such as for example, random access memory (RAM), and/or a non-transitory memory such as, for example, a non-transitory computer readable medium such as, for example, persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a virtual shopping cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product data. It may be that themes can be further customized through a theme editor, a design interface that enables users to customize their website's design with flexibility. Additionally, or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

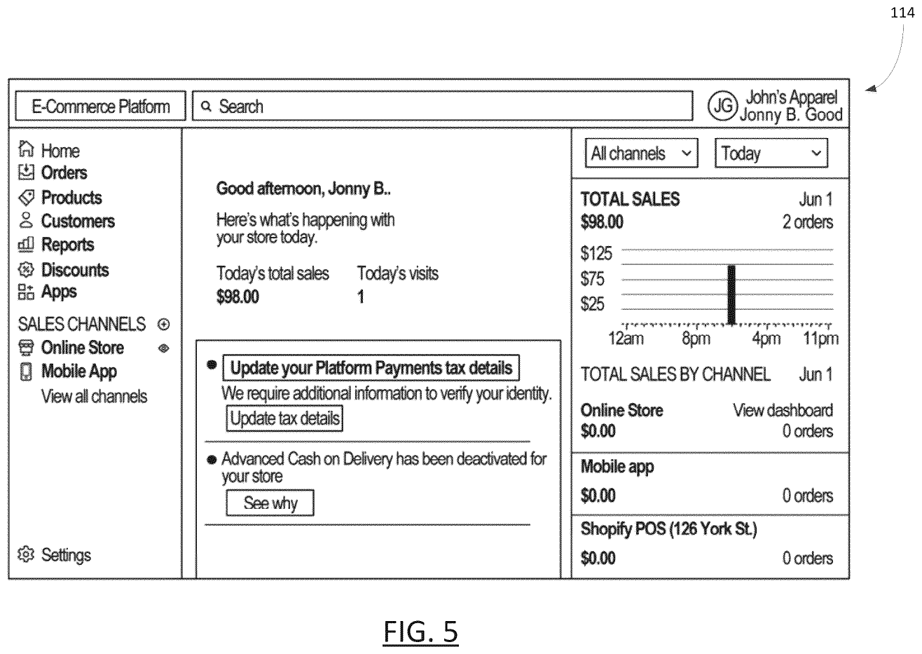

FIG. 5 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 4. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned virtual shopping carts, and/or other transactional information associated with business through the e-commerce platform 100. In some embodiments, the e-commerce platform 100 may store this data in a data facility 134. Referring again to FIG. 4, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138. The commerce management engine 136 may interact with an analytics 132 module that performs analysis using the data 134 stored on the e-commerce platform 100.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their virtual shopping cart, proceeds to checkout, and pays for the content of their virtual shopping cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) to transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and tracks quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g., Long-Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method comprising:
receiving, at a computing device, a job request having an associated query referencing one or more fields of a data object conforming to a schema;
determining, by the computing device, a resultant scaling factor based on the one or more fields selected by the associated query and the data shape of those one or more fields in the data object, at least one of the one or more fields having an associated scale factor specified in the schema;
adjusting an allocation limit based on the resultant scaling factor to produce an adjusted allocation limit, the allocation limit being a per-job allocation of a computing resource for execution of the job request; and
executing, by the computing device, the job request subject to the adjusted allocation limit.

2. The method of claim 1, wherein receiving includes receiving a compute job to execute, wherein the query is associated with the compute job, and wherein executing includes executing the compute job subject to the adjusted allocation limit.

3. The method of claim 1, wherein executing the job request subject to the adjusted allocation limited includes:
comparing a job execution parameter to the adjusted allocation limit;
determining that the job execution parameter exceeds the adjusted allocation limit; and
responsive to determining that the job execution parameter exceeds the adjusted allocation limit, terminating execution of the job request prior to its completion.

4. The method of claim 3, wherein the job execution parameter corresponds to a least one of a CPU instruction count, a virtual machine instruction count, or processor time.

5. The method of claim 1, wherein the data shape includes a count of the one or more fields in the data object.

6. The method of claim 1, wherein the data shape includes a size of the one or more fields in the data object.

7. The method of claim 1, wherein determining the resultant scaling factor includes multiplying the associated scale factor for one of said at least one of the one or more fields of the schema by a field size or row count for the one of said one or more fields in the data object.

8. The method of claim 1, wherein the schema specifies a first scale factor associated with a first one of the one or more fields and a second scale factor associated with a second one of the one or more fields, and wherein determining the resultant scaling factor includes:
determining a first resultant scaling factor based on the first scale factor and the data shape of the first one of the one or more fields in the data object;
determining a second resultant scaling factor based on the second scale factor and the data shape of the second one of the one or more fields in the data object; and
determining the resultant scaling factor using the first resultant scaling factor and the second resultant scaling factor.

9. The method of claim 8, wherein determining the resultant scaling factor using the first resultant scaling factor and the second resultant scaling factor includes comparing and selecting the larger of the first resultant scaling factor and the second resultant scaling factor as the resultant scaling factor.

10. The method of claim 1, wherein the associated query is a GraphQL query and wherein the schema includes a directive specifying the associated scale factor associated with the at least one of the one or more fields.

11. The method of claim 1, wherein the computing device comprises a multi-user computing platform and the job request includes an application program executing on the multi-user computing platform in response to a customer user input received at the multi-user computing platform, and wherein the data object is a user-specific data object generated in response to customer user input activity on the multi-user computing platform.

12. A computing platform, comprising:
one or more processors; and
memory coupled to at least one of the one or more processors, the memory storing computer-executable instructions that, when executed by the one or more processors, are to cause the one or more processors to:
receive a job request having an associated query referencing one or more fields of a data object conforming to a schema;
determine a resultant scaling factor based on the one or more fields selected by the associated query and the data shape of those one or more fields in the data object, at least one of the one or more fields having an associated scale factor specified in the schema;
adjust an allocation limit based on the resultant scaling factor to produce an adjusted allocation limit, the allocation limit being a per-job allocation of a computing resource for execution of the job request; and
execute the job request subject to the adjusted allocation limit.

13. The computing platform of claim 12, wherein the instructions, when executed, are to cause the one or more processors to execute the job request subject to the adjusted allocation limited by at least:
comparing a job execution parameter to the adjusted allocation limit;
determining that the job execution parameter exceeds the adjusted allocation limit; and
responsive to determining that the job execution parameter exceeds the adjusted allocation limit, terminating execution of the job request prior to its completion.

14. The computing platform of claim 13, wherein the job execution parameter corresponds to a least one of a CPU instruction count, a virtual machine instruction count, or processor time.

15. The computing platform of claim 12, wherein the data shape includes a count of the one or more fields in the data object.

16. The computing platform of claim 12, wherein the data shape includes a size of the one or more fields in the data object.

17. The computing platform of claim 12, wherein the instructions, when executed, are to cause the one or more processors to determine the resultant scaling factor by, at least, multiplying the associated scale factor for one of said at least one of the one or more fields of the schema by a field size or row count for the one of said one or more fields in the data object.

18. The computing platform of claim 12, wherein the schema specifies a first scale factor associated with a first one of the one or more fields and a second scale factor associated with a second one of the one or more fields, and wherein the instructions, when executed, are to cause the one or more processors to determine the resultant scaling factor by, at least:
determining a first resultant scaling factor based on the first scale factor and the data shape of the first one of the one or more fields in the data object;
determining a second resultant scaling factor based on the second scale factor and the data shape of the second one of the one or more fields in the data object; and
determining the resultant scaling factor using the first resultant scaling factor and the second resultant scaling factor.

19. The computing platform of claim 18, wherein determining the resultant scaling factor using the first resultant scaling factor and the second resultant scaling factor includes comparing and selecting the larger of the first resultant scaling factor and the second resultant scaling factor as the resultant scaling factor.

20. The computing platform of claim 12, wherein the associated query is a GraphQL query and wherein the schema includes a directive specifying the associated scale factor associated with the at least one of the one or more fields.

21. The computing platform of claim 12, wherein the computing platform comprises a multi-user computing platform and the job request includes an application program executing on the multi-user computing platform in response to a customer user input received at the multi-user computing platform, and wherein the data object is a user-specific data object generated in response to customer user input activity on the multi-user computing platform.

22. A non-transitory processor-readable medium storing processor-executable instructions that, when executed by one or more processors, are to cause the one or more processors to:
receive a job request having an associated query referencing one or more fields of a data object conforming to a schema;
determine a resultant scaling factor based on the one or more fields selected by the associated query and the data shape of those one or more fields in the data object, at least one of the one or more fields having an associated scale factor specified in the schema;
adjust an allocation limit based on the resultant scaling factor to produce an adjusted allocation limit, the allocation limit being a per-job allocation of a computing resource for execution of the job request; and
execute the job request subject to the adjusted allocation limit.
